(19) United States
(12) Patent Application Publication
(10) Pub. No.: US 2025/0062841 A1
(43) Pub. Date: Feb. 20, 2025

(54) MULTIPLE ACCESS POINT (AP) ASSOCIATION

(71) Applicant: QUALCOMM Incorporated, San Diego, CA (US)

(72) Inventors: Raviteja PATCHAVA, San Diego, CA (US); Piyush GUPTA, Bridgewater, NJ (US)

(21) Appl. No.: 18/450,350

(22) Filed: Aug. 15, 2023

(51) Int. Cl. H04B 17/309; H04W 72/044

(52) U.S. Cl. CPC H04B 17/309; H04W 72/046

(57) ABSTRACT

A wireless communication device may include one or more memories, individually or in combination, having instructions and one or more processors, individually or in combination, configured to execute the instructions. In some examples, the wireless communication device may be configured to transmit a first signal. In some examples, the wireless communication device may be configured to transmit, after the first signal, a first plurality of signals including a second signal, wherein each of the plurality of signals is transmitted via one of a plurality of codebook directional beams. In some examples, the wireless communication device may be configured to receive, from a first energy harvesting (EH) device of a plurality of EH devices, a first backscatter signal in response the second signal, wherein the first backscatter signal indicates that the second signal satisfies a threshold condition.

### BACKGROUND

### Technical Field

The present disclosure generally relates to communication systems, and more particularly, to association between a wireless device and multiple access points (APs).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a network entity. In some examples, the method includes transmitting a first signal. In some examples, the method includes transmitting, after the first signal, a first plurality of signals including a second signal, wherein each of the plurality of signals is transmitted via one of a plurality of codebook directional beams. In some examples, the method includes receiving, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal.

Certain aspects are directed to a method of wireless communication at an energy harvesting (EH) device. In some examples, the method includes receiving a first signal. In some examples, the method includes receiving, after the first signal, a second signal. In some examples, the method includes transmitting a first backscatter signal in response the second signal, wherein transmission of the first backscatter signal indicates that the second signal satisfies a threshold condition, and wherein the threshold condition is based at least in part on a strength of the first signal.

Certain aspects are directed to a network entity configured for wireless communication. In some examples, the network entity includes one or more memories, individually or in combination, having instructions. In some examples, the network entity includes one or more processors, individually or in combination, configured to execute the instructions. In some examples, the one or more processors are configured to cause the network entity to: transmit a first signal. In some examples, the one or more processors are configured to cause the network entity to transmit, after the first signal, a first plurality of signals including a second signal, wherein each of the plurality of signals is transmitted via one of a plurality of codebook directional beams. In some examples, the one or more processors are configured to cause the network entity to receive, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal.

Certain aspects are directed to an energy harvesting (EH) device. In some examples, the EH device includes one or more memories, individually or in combination, having instructions. In some examples, the EH device includes one or more processors, individually or in combination, configured to execute the instructions. In some examples, the one or more processors are configured to cause the EH device to: receive a first signal. In some examples, the one or more processors are configured to cause the EH device to receive, after the first signal, a second signal. In some examples, the one or more processors are configured to cause the EH device to transmit a first backscatter signal in response the second signal, wherein transmission of the first backscatter signal indicates that the second signal satisfies a threshold condition, and wherein the threshold condition is based at least in part on a strength of the first signal.

Certain aspects are directed to an apparatus for wireless communication. In some examples, the apparatus includes means for transmitting a first signal. In some examples, the apparatus includes means for transmitting, after the first signal, a first plurality of signals including a second signal, wherein each of the plurality of signals is transmitted via one of a plurality of codebook directional beams. In some examples, the apparatus includes means for receiving, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal.

Certain aspects are directed to an apparatus for wireless communication. In some examples, the apparatus includes means for receiving a first signal. In some examples, the apparatus includes means for receiving, after the first signal, a second signal. In some examples, the apparatus includes means for transmitting a first backscatter signal in response the second signal, wherein transmission of the first backscatter signal indicates that the second signal satisfies a threshold condition, and wherein the threshold condition is based at least in part on a strength of the first signal.

Certain aspects are directed to a non-transitory, computer-readable medium comprising computer executable code that, when executed by one or more processors, causes the one or more processors to, individually or in combination, perform an operation. In some examples, the operations include transmitting a first signal. In some examples, the operations include transmitting, after the first signal, a first plurality of signals including a second signal, wherein each of the plurality of signals is transmitted via one of a plurality of codebook directional beams. In some examples, the operations include receiving, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal.

Certain aspects are directed to a non-transitory, computer-readable medium comprising computer executable code that, when executed by one or more processors, causes the one or more processors to, individually or in combination, perform an operation. In some examples, the operations include receiving a first signal. In some examples, the operations include receiving, after the first signal, a second signal. In some examples, the operations include transmitting a first backscatter signal in response the second signal, wherein transmission of the first backscatter signal indicates that the second signal satisfies a threshold condition, and wherein the threshold condition is based at least in part on a strength of the first signal.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a block diagram illustrating an example architecture of a disaggregated base station comprising multiple components.

FIG. 5 illustrates a simplified block diagram of a network entity functional as a radio frequency identifier (RFID) reader/source, communicating and controlling an energy harvesting (EH) device in a wireless communications system.

FIG. 6 is a block diagram illustrating example communication signals including continuous wave (CW) and modulated command signals between a network entity and an EH device.

FIG. 7 is a block diagram and call-flow diagram illustrating example wireless communications between a network entity and multiple EH devices.

FIG. 8 is a block diagram and call-flow diagram illustrating example wireless communications between a network entity and multiple EH devices.

FIG. 9 is a flowchart of a method of wireless communication.

FIG. 10 is a diagram illustrating an example of a hardware implementation for an example apparatus.

FIG. 11 is a flowchart of a method of wireless communication.

FIG. 12 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects of the disclosure are directed to channel measurement for beam sweeping between a network entity configured for radio frequency identification (RFID) communication and a user equipment (UE) configured as an energy harvesting (EH) device, such as an RFID tag, or any other device capable of harvesting electromagnetic energy. Although aspects of the disclosure may describe examples of an “RFID tag,” such examples are equally applicable to other suitable EH devices. The efficiency and range of RFID communications may be improved by beamforming signals from the network entity. However, such beamforming may require the network entity to estimate the channel between it and one or more tags. In the case of a large number of RFID tags, individual channel estimation becomes a rather tedious task.

To address this issue, two techniques are described. A first technique relates to channel measurement via an omnidirectional transmission and a beam sweep, and a second technique relates to channel measurement via a multi-stage beam sweep.

In the first technique, the network entity may begin channel estimation by transmitting a signal via an omni-directional beam. The signal may be used as a reference signal for signal strength measurements by EH devices. For example, an EH device may measure the strength of the reference signal. The network entity may then begin a time-division multiplexed beam sweep, by transmitting signals to the EH devices via multiple beams. The EH devices may receive and measure signaling via one or more of the multiple beams and determine whether to respond to the beamformed signaling with a backscatter signal. The EH devices may determine to respond to the beamformed signaling if a measured strength of the received signaling is greater than a threshold value that is based, at least in part, on the measured signal strength of the omni-directional beam. As such, whether an EH device responds to one or more of the beamformed signals may be based on a measured signal strength of a received beamformed signal relative to the signal strength of the omni-directional beam.

In the second technique, the network entity may begin channel estimation by performing a first time-division multiplexed beam sweep. Here, the EH devices may measure the strength of each received signal and store the measured information. The network entity may then perform a second beam sweep using the same beams as the first beam sweep. The EH devices, having information indicating which beam had the highest quality or signal strength, may transmit a backscatter response to the network entity when the EH device receives a signal corresponding to that beam.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

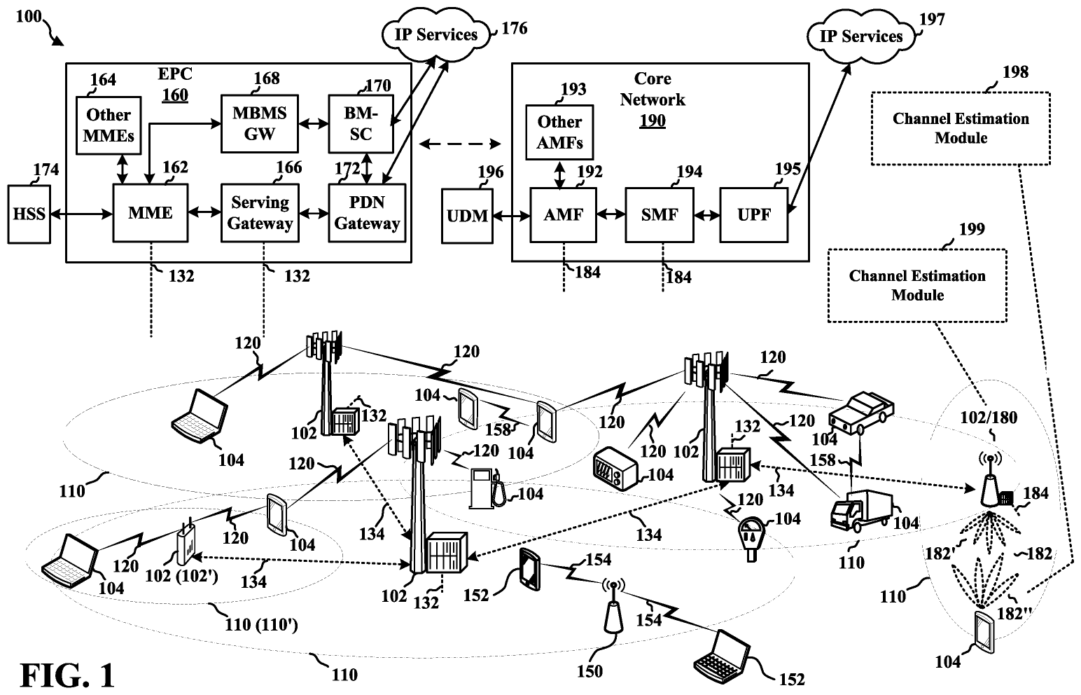

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. As used herein, a UE may be configured for functionality as an energy harvesting (EH) device (e.g., an RFID tag). As used herein the terms “network entity” and “base station” may be used interchangeably, although “network entity” may also relate to a disaggregated portion of a base station.

Referring again to FIG. 1, the UE 104 may include a channel estimation module 198 and may be configured to function as an EH device. As described in more detail elsewhere herein, the channel estimation module 198 may be configured to receive a first signal; receive, after the first signal, a second signal; and transmit a first backscatter signal in response the second signal, wherein transmission of the first backscatter signal indicates that the second signal satisfies a threshold condition, and wherein the threshold condition is based at least in part on a strength of the first signal. Additionally, or alternatively, the channel estimation module 198 may perform one or more other operations described herein.

The base station 102/180 may include a channel estimation module 199 and may be configured to function as an RFID reader/source. As described in more detail elsewhere herein, the channel estimation module 199 may be configured to transmit a first signal; transmit, after the first signal, a first plurality of signals including a second signal, wherein each of the plurality of signals is transmitted via one of a plurality of codebook directional beams; and receive, from a first EH device of a plurality of EH devices, a first backscatter signal in response the second signal, wherein the first backscatter signal indicates that the second signal satisfies a threshold condition, and wherein the threshold condition is based at least in part on a strength of the first signal. Additionally, or alternatively, the channel estimation module 199 may perform one or more other operations described herein.

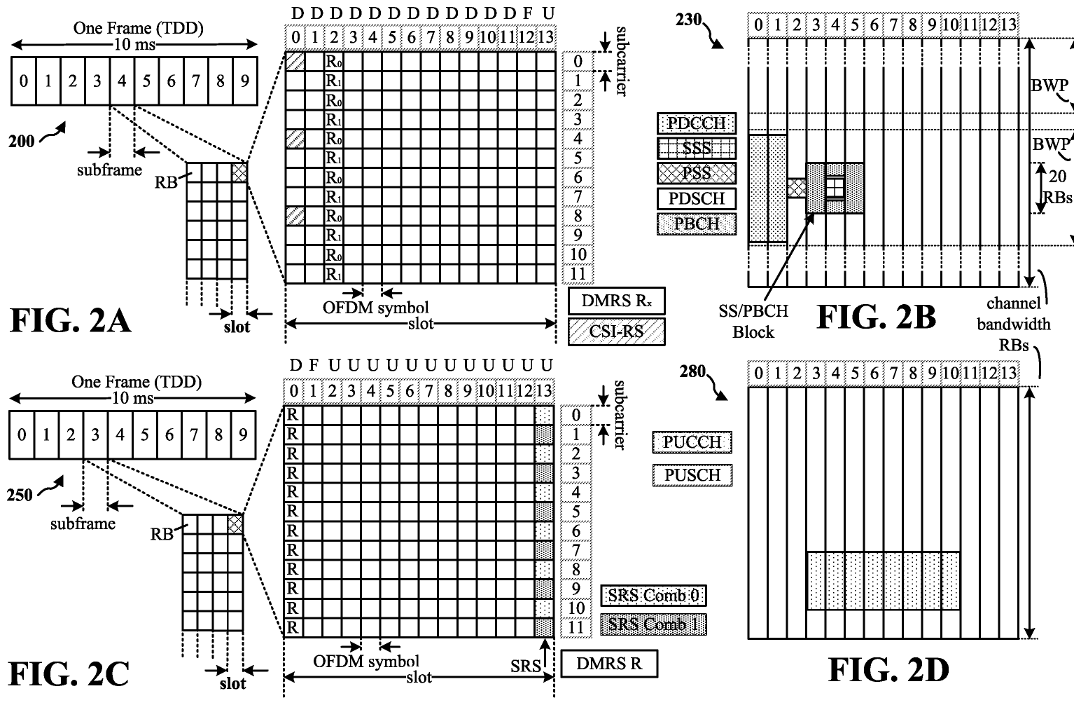

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

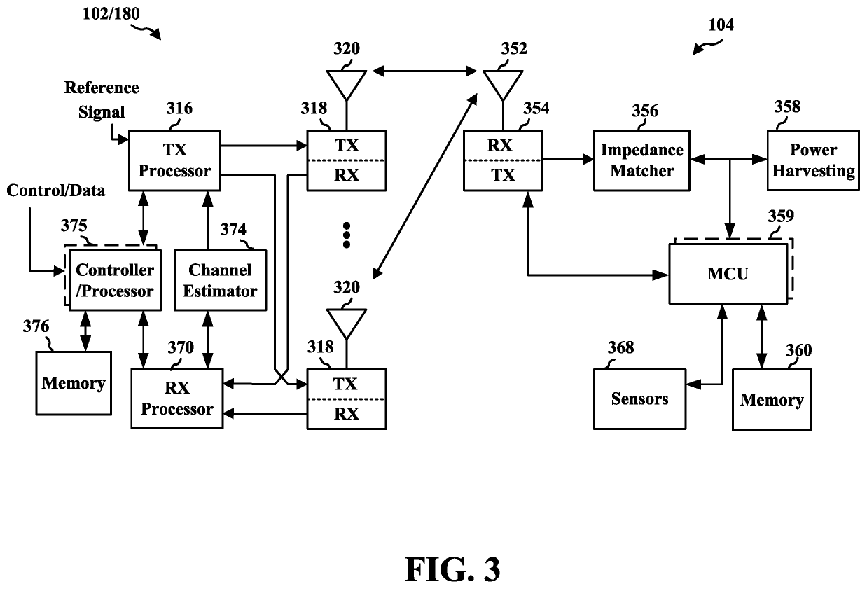

FIG. 3 is a block diagram of a base station 102/180 configured as an RFID reader/source in communication with a UE 104 implemented as an EH device (e.g., an RFID tag) in a network. In the DL, IP packets from the EPC 160 may be provided to one or more controller/processors 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, one or more receivers/transmitters 354 receives a signal through its respective antenna 352. Each receiver/transmitter 354 is configured as a modulator and demodulator. In some examples, receiver/transmitter 354 may performing demodulation of a received incoming modulated carrier waveform. Demodulation is the act of removing the modulation from the incoming analog signal. The receiver/transmitter 354 is meant to represent the circuitry for the demodulation technique employed in certain embodiments. In some examples, modulation techniques used by the receiver/transmitter 354 may include any suitable modulation technique, such as ASK, PSK, FSK, QAM, or the like. The receiver/transmitter 354 may use a plurality of modulation schemes in communication with the base station 102/180 or other EH devices/RFID tags. In embodiments, the return modulation scheme may be PSK, a digital modulation scheme that conveys data by changing, or modulating, the phase of the carrier wave. The carrier wave for transmission of the modulated signal may be the backscattered carrier wave received from the base station 102/180.

A received signal may input to an impedance matcher 356 configured to perform impedance matching. Impedance matching may attempt to make the output impedance of a source, the antenna 352 for instance, equal to the input impedance of the UE 104. Impedance matching may be implemented in order to maximize the power transfer and minimize reflections from the load. The concept of impedance matching may be applied when energy is transferred between a source and a load. The UE 104 may include a power harvesting circuit 358 configured to generate a DC power output to power a microcontroller unit (MCU) 359, a memory 360, one or more sensors 368, and the receiver/transmitter 354.

The receiver/transmitter 354 may demodulate an input signal and convert the analog signal to a digital signal. The digital signal may be passed to the MCU 359 for processing, as discussed herein. When processing is complete, any required response and/or data return message to the base station 102/180 may be sent from the MCU to the receiver/transmitter 354 to be modulate prior to transmission. In some examples, the base station 102/180 may transmit configuration information to the UE 104. In this example, the MCU 359 may store the configuration information in a memory 360 so that it can be recalled later. The memory 360 may be referred to as a computer-readable medium.

The base station 102/180 may receive and process backscattered transmissions from the UE 104. For example, each transmitter/receiver 318 may receive a backscatter signal through its respective antenna 320. Each transmitter/receiver 318 recovers information modulated onto an RF carrier and provides the information to an RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

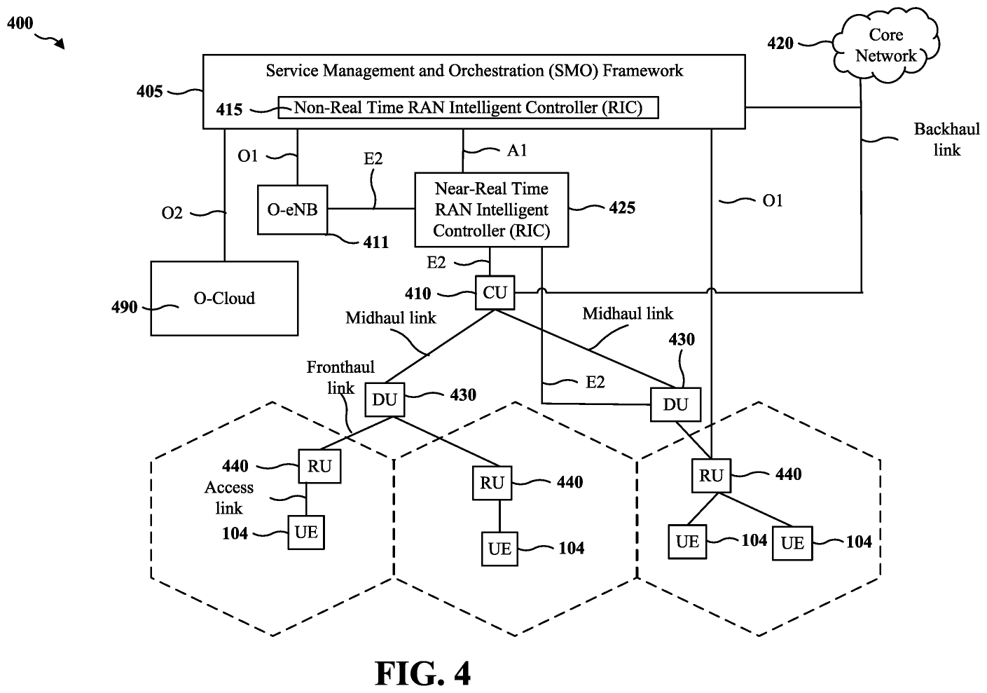

FIG. 4 is a block diagram illustrating an example architecture of a disaggregated base station 400 comprising multiple components. The disaggregated base station 400 architecture may include one or more CUs 410 that can communicate directly with a core network 420 via a backhaul link, or indirectly with the core network 420 through one or more disaggregated base station units (such as a near real-time (RT) RIC 425 via an E2 link, or a non-RT RIC 415 associated with a service management and orchestration (SMO) Framework 405, or both). A CU 410 may communicate with one or more DUs 430 via respective midhaul links, such as an F1 interface. The DUs 430 may communicate with one or more RUs 440 via respective fronthaul links. The RUs 440 may communicate with respective UEs 104 via one or more radio frequency (RF) access links. In some implementations, the UE 104 may be simultaneously served by multiple RUs 440. As used herein, a network entity may correspond to a base station or to a disaggregated aspect (e.g., CU/DU/RU, etc.) of the base station.

Each of the units, i.e., the CUs 410, the DUs 430, the RUs 440, as well as the near-RT RICs 425, the non-RT RICs 415 and the SMO framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., central unit-user plane (CU-UP)), control plane functionality (i.e., central unit-control plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a virtual RAN (vRAN) architecture.

The SMO Framework 405 may be configured to support RAN deployment and provisioning of non-virtualized and virtualized network elements. For non-virtualized network elements, the SMO framework 405 may be configured to support the deployment of dedicated physical resources for RAN coverage requirements, which may be managed via an operations and maintenance interface (such as an O1 interface). For virtualized network elements, the SMO framework 405 may be configured to interact with a cloud computing platform (such as an open cloud (O-cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and near-RT RICs 425. In some implementations, the SMO framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO framework 405 also may include the non-RT RIC 415 configured to support functionality of the SMO Framework 405.

The non-RT RIC 415 may be configured to include a logical function that enables non-real-time control and optimization of RAN elements and resources, artificial intelligence/machine learning (AI/ML) workflows including model training and updates, or policy-based guidance of applications/features in the near-RT RIC 425. The non-RT RIC 415 may be coupled to or communicate with (such as via an A1 interface) the near-RT RIC 425. The near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the near-RT RIC 425.

In some implementations, to generate AI/ML models to be deployed in the near-RT RIC 425, the non-RT RIC 415 may receive parameters or external enrichment information from external servers. Such information may be utilized by the near-RT RIC 425 and may be received at the SMO Framework 405 or the non-RT RIC 415 from non-network data sources or from network functions. In some examples, the non-RT RIC 415 or the near-RT RIC 425 may be configured to tune RAN behavior or performance. For example, the non-RT RIC 415 may monitor long-term trends and patterns for performance and employ AI/ML models to perform corrective actions through the SMO Framework 405 (such as reconfiguration via 01) or via creation of RAN management policies (such as A1 policies).

### Introduction to Radio-Frequency Identification (RFID) Devices

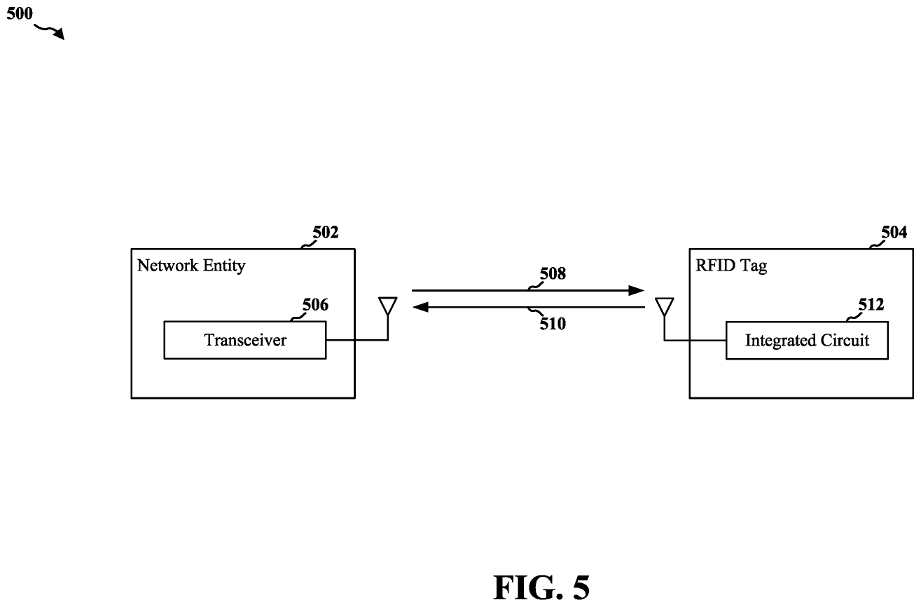

FIG. 5 illustrates a simplified block diagram of a network entity 502 (e.g., a base station 102 or a component of a base station 102 functional as an RFID reader), communicating and controlling an EH device functional as a passive internet of things (IoT) device (e.g., an RFID tag 504) in a wireless communications system 500. The network entity 502 may be any suitable device configured as a wireless communication node within a network (e.g., machine type communication (MTC), massive MTC (mMTC), access network 100, IoT, industrial IoT (IIoT), narrowband IoT (NB-IoT), etc.). The network entity 502 may also be implemented at least in part within an AN as a smart repeater, an RF repeater, a reflector (e.g., intelligent reflective surface (IRS) or reconfigurable intelligent surface (RIS)). The RFID tag 504 is one possible RFID tag associated with, for example, a passive IoT (PIoT). Although “RFID tag” and simply “tag” are used throughout the disclosure, any suitable EH device may implement the methods and techniques described herein.

RFID tag 504 can be either a passive, active, or battery-assisted passive. An active RFID tag has an on-board battery and periodically transmits its ID signal. A battery-assisted passive (BAP) RFID tag has a small battery on board and is activated when in the presence of network entity 502. A passive RFID tag is typically cheaper and smaller because it has no battery; instead, the passive RFID tag uses the radio energy transmitted by the network entity 502 for power. However, to operate a passive RFID tag, it must be illuminated with a power level relatively larger than required for the BAP RFID tag to transmit a signal transmission.

RFID tag 504 may either be read-only, having a factory-assigned serial number that is used as a key into a database, or may be read/write, where object-specific data can be written into the tag by the system user. Field programmable tags may be write-once, read-multiple; “blank” tags may be written with an electronic product code by the user.

RFID tag 504 may contain at least two parts: (1) an integrated circuit 512 for storing and processing information, modulating and demodulating a received RF signal, collecting DC power from the incident reader signal, generating a backscatter modulated information signal, and other specialized functions; and (2) an antenna for receiving and transmitting the backscatter modulated information signal 510. The tag information may be stored in a non-volatile memory contained in the RFID tag 504. The RFID tag 504 may include either fixed or programmable logic for processing the transmission and sensor data, respectively.

The transceiver 506 of the network entity 502 transmits one or more messages by way of a continuous RF wave 508 to energize and interrogate the RFID tag 504. Although FIG. 5 illustrates transceiver 506 as transmitting one continuous RF wave 508, in other aspects the transceiver 506 may be configured to generate multiple continuous RF waves using one or more directional beams and/or an omni-directional beam. The RFID tag 504 receives the message and then responds with its identification and other information by generating a backscatter modulated information signal 510. The identification may be a unique tag serial number, and the other information may be product-related information such as a stock number, lot or batch number, production date, or other specific information. Since RFID tags 504 have individual serial numbers, the network entity 502 can discriminate among several tags that might be within the range of the network entity 502 and read them simultaneously. A passive RFID tag generates the backscatter modulated information signal 510 by reflecting back a portion of the continuous RF wave 508 in a process known as backscatter. Thus, the frequency of the backscatter modulated information signal 510 is determined by the frequency of the continuous RF wave 508. That is, in one example the frequency of the backscatter modulated information signal 510 is equal to the frequency of the continuous RF wave 508 received at the RFID tag 504.

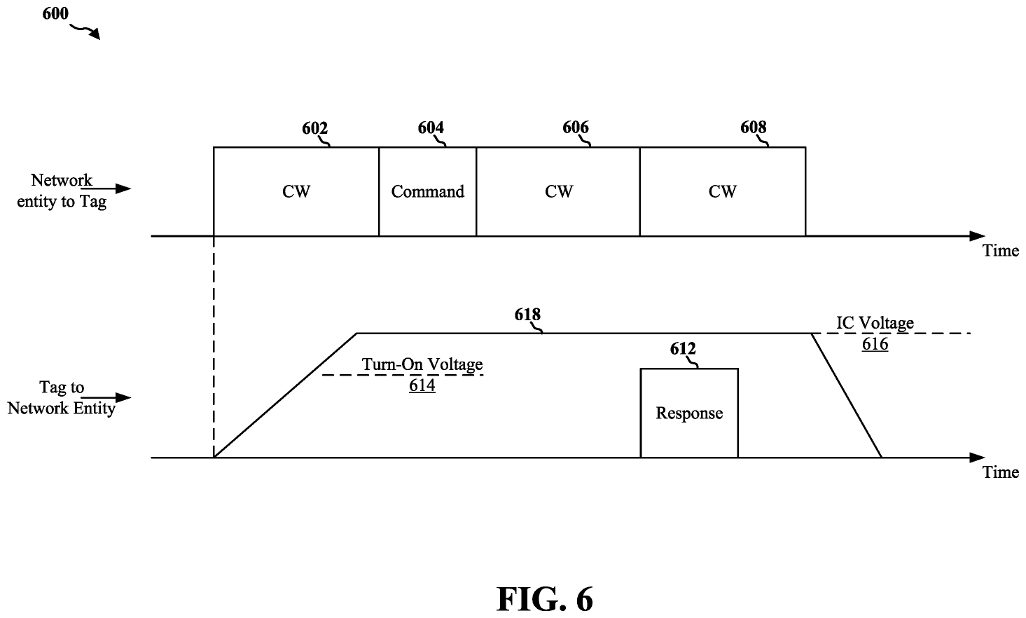

In certain aspects, the network entity 502 may transmit one or a combination of a continuous wave (CW) signal and a modulated command signal to the RFID tag 504. For examples, FIG. 6 is a block diagram illustrating example communication signals 600 including CW and modulated command signals between a network entity (e.g., network entity 502 of FIG. 5) and a tag (e.g., tag RFID 504 of FIG. 5).

Initially, the network entity may transmit a first CW 602 to the tag in order to power up the tag. In one example, the first CW 602 may be equal to or greater than 400 μs in duration. The first CW 602 may provide the tag with enough power to reach a minimum turn-on voltage 614 required by the tag and a minimum IC voltage 616 to power an integrated circuit of the tag. A power level 618 is illustrated to show an example power level provided by the transmitted signaling of the network entity.

After the first CW 602, the network entity may transmit a first command 604 that carries information for programming the tag and/or for modulation and backscattering by the tag. For example, the tag may modulate a received signal to generate an output signal having a sequence produced via amplitude-shift keying (ASK), frequency-shift keying, on-off-keying (OOK), or any other suitable method of signal modulation. The tag may also apply a frequency shift to the received signal to generate the output signal so that the output signal is frequency-shifted relative to the received signal. For example, if the received signal is transmitted at 18 GHz, the tag may output a backscatter signal at 17 GHz or 19 GHz. The tag may be configured to output a backscatter signal having a frequency that has been shifted relative to the received signal by any suitable delta value (e.g., between 0 and 30 GHz). The first command may also provide enough power to maintain the minimum required IC voltage 616.

A second CW 606 and a third CW 608 may be transmitted to maintain power at the tag while the tag modulates and transmits a backscatter response 612 in response to one or more of the CWs and/or the first command 604. In some examples, the tag may modulate the backscatter response 612 so that a sequence is transmitted and/or the response is a frequency-shifted version of the received first command 604 or CW. The CWs and first command 604 may be transmitted using directional beams. As used herein, a CW signal may relate to a contiguous signal that contains both CW and command elements, as illustrated in FIG. 6, or a contiguous signal containing only CW elements.

RFID supports only short-range (e.g., less than 10 meters) for passive IoT due to a relatively small link budget, making the power link (e.g., downlink, network entity to tag) a bottleneck link. For example, the power harvesting circuitry of the tag typically requires high input power (e.g., −13 dBm), whereas a lower input power (e.g., −20 dBm or below) may reduce communication reliability between the network entity and the tag. Reflections by multi-path can also cause fading to the energy signal and degrades the range, especially in an IIoT or mMTC scenario. Accordingly, transmitting beamformed signals (e.g., signals transmitted using directional beams) may increase the efficiency and range of power transfer between the network entity and tag.

However, using beamformed signaling at the network entity may be most efficiently implemented by estimating the channel between the network entity and the tag. However, in a scenario where a large number of tags are located within an area, an estimation of individual channels becomes difficult. Thus, according to aspects of the disclosure, the network entity may provide EH devices with a reference transmission that each tag may use to selectively respond to the network entity. That is, the network entity may transmit a reference transmission to one or more tags in different locations so that each tag may use the reference transmission to determine which subsequent network entity transmission to backscatter.

### Examples of Channel Measurement Via Omnidirectional Transmission and Beam Sweep

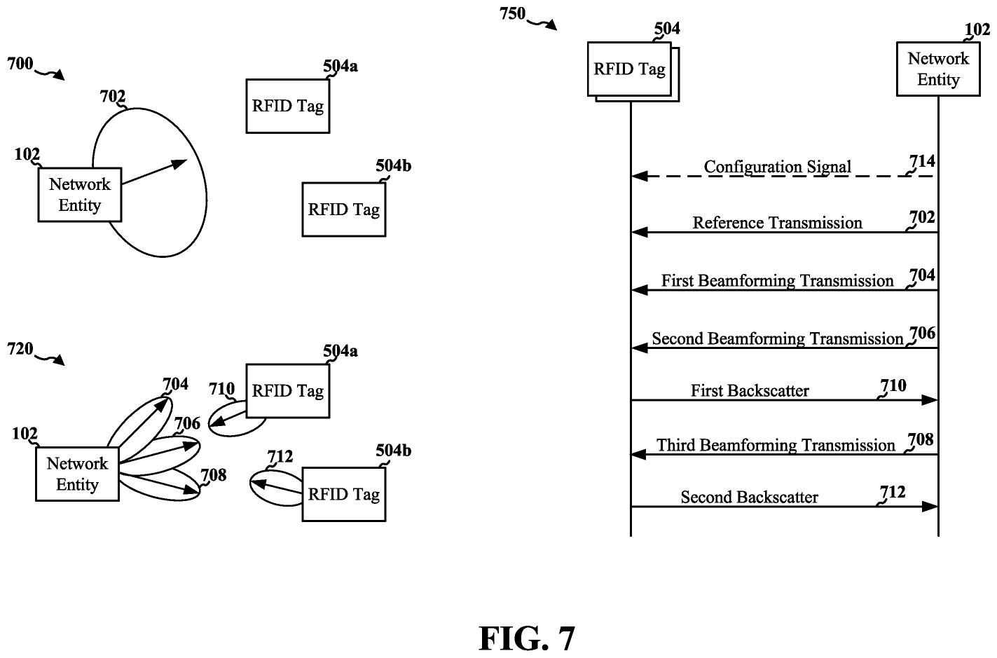

FIG. 7 is a block diagram and call-flow diagram 750 illustrating example wireless communications between a network entity 502 (e.g., base station 102/180 of FIGS. 1 and 3) and multiple RFID tags 504 (e.g., UE 104 of FIGS. 1 and 3; first RFID tag 504a and second RFID tag 504b).

Initially, the network entity 502 may transmit a configuration signal 714 to the multiple RFID tags 504. The configuration signal 714 may be configured to provide the RFID tags 504 with notice of a future beam sweep operation performed between the network entity 502 and the RFID tags 504. In some examples, the configuration signal 714 may also provide the tags 504 with an indication of a threshold value (e.g., an integer). The configuration signal 714 may be transmitted using an omni-directional beam or a quasi-omni-directional beam (e.g., relatively wide directional beam configured based on locations of the tags 504).

At a first step 700 of the beam sweep operation, the network entity 502 may transmit a reference transmission 702 to the tags 504. The reference transmission 702 may be transmitted using an omni-directional beam or a quasi-omni-directional beam. The tags 504 may receive the reference transmission 702 and measure the strength (e.g., in dBm or any other suitable unit of measure) of the signal. In some examples, the reference transmission may be transmitted with one or more of a CW signal and/or a command that the tags 504 measure the strength of the reference transmission.

At a second step 720 of the beam sweep operation, the network entity 502 may begin transmitting to the tags 504 signaling via directional beams (e.g., first beam 704, second beam 706, and third beam 708). The directional beams may be defined by a codebook used by the network entity 502. At the second step 720 of the beam sweep operation, the network entity 502 may transmit signaling to the tags 504 using one or more beams from the codebook (e.g., in some cases, the network entity 502 may transmit signaling using each beam from the codebook). The network entity 502 may transmit signaling via each beam in a time-division manner. That is, the network entity 502 may transmit signaling via the first beam 704 within a first time window, and transmit signaling via the second beam 706 within a second time window, wherein the first time window occurs prior to the second time window. As such, the network entity 502 provides the tags 504 with an opportunity to backscatter a particular signal using one beam at a time.

Each tag 504 that receives the reference transmission 702 may use the measured strength of the reference transmission 702 to determine whether a particular beam used in the second step 720 satisfies a threshold condition. If a tag determines that a beam satisfies the threshold condition, that tag may backscatter the signal transmitted via the beam back to the network entity 502. In one example, the threshold value provided to the tags 504 via the configuration signal 714 may be an integer value. In this example, each tag 504 may measure the strength of signaling received via the reference transmission 702 and add the threshold value to that measured strength. The sum of the threshold value and the reference transmission 702 strength may be used by each tag 504 as a threshold condition.

For example, the first RFID tag 504a may be geographically closer to the network entity 502 than the second RFID tag 504b. Accordingly, the first RFID tag 504a may measure a higher signal strength associated with the reference transmission 702 relative to the measured reference transmission 702 strength of the second RFID tag 504b. However, the threshold value received by both tags may be the same value. Thus, the threshold condition may be a function of the measured strength of the reference transmission 702 as it may vary across different tags 504. During the second step 720, each tag may receive signaling transmitted via one or more beam from the network entity 502. Each tag 504 may measure the signal strength of each signal received via the one or more beams and determine whether the measured strength is greater than or equal to the sum of the threshold value and the reference transmission 702 strength. If a tag determines that the measured signal strength of a beam is greater than or equal to the sum, then the threshold condition is satisfied, and that tag may backscatter the beamformed signal back to the network entity 502.

For example, the first RFID tag 504a may measure the signal strength of the reference transmission 702 as −8 dBm, and the second RFID tag 504b may measure the signal strength of the reference transmission 702 as −10 dBm. The configuration signal 714 may configure the tags 504 with a threshold value of 2. Accordingly, the first RFID tag 504a may only respond with a backscatter signal to beams transmitted by the network entity 502 during the second step 720 if the measured the signal strength of a given beam is equal to or stronger (greater) than −6 dBm, and the second RFID tag 504b may only respond with backscatter to beams with a measured strength of −8 dBm.

As illustrated, the first RFID tag 504a may receive signaling via a first beam 704, but if the signal transmitted via that beam is measured by the first RFID tag 504a and it is less than −6 dBm, the first RFID tag 504a will not respond. The network entity 502 may then transmit signaling via a second beam 706. Here, the first RFID tag 504a may measure the signal and determine that the signal satisfies the threshold condition (e.g., the signal strength of the second beam 706 (from the perspective of the first RFID tag 504a) is equal to or greater than −6 dBm). Because the threshold condition is satisfied, the first RFID tag may transmit a first backscatter signal 710 based on the signal received via the second beam 706 to the network entity 502. The network entity 502 may then transmit signaling via a third beam 708. Here, the second RFID tag 504b may measure the signal and determine that the measured signal has a strength that is equal to or greater than −8 dBm. Thus, because the threshold condition at the second RFID tag 504b is satisfied, the second RFID tag 504b may transmit a second backscatter signal 712 back to the network entity 502.

In certain aspects, the tags 504 may modulate backscattered signals by applying, to a signal output from the tag 504, Gaussian frequency-shift keying (GFSK), amplitude-shift keying (ASK), on-off-keying (OOK), or any other suitable method of frequency-shift keying (FSK) and/or signal modulation. The tags 504 may also, or alternatively, generate a backscatter signal by applying a frequency shift to the received signal.

In certain aspects, the tags 504 may generate a backscatter signal characterized by a frequency shift and/or a bit sequence based on an amount of power received from each beam that satisfies the threshold condition. As such, each tag can provide an indication to the network entity of which beams provide the highest level of power. For example, a minimal amount of frequency shifting may indicate that the measured power of a corresponding beam provides enough power to be equal to the threshold condition. As the power measured by a tag increases, the frequency shift may become more dramatic. Similarly, the network entity 502 may be configured to identify which tags 504 are transmitting backscattered signals according to a bit-sequence associated with each backscattered signal. For example, each tag 504 may modulate their backscattered signals to include a bit-sequence unique to a corresponding tag.

In certain aspects, each tag 504 may also refrain from transmitting a backscatter signal if the received power in the omni directional transmission is higher than a certain threshold (e.g., the tag is close to the network entity 502). This particular threshold may be configured by the network entity for the tags 504 via the configuration signal 714. In this case, if the first RFID tag 504a is so close to the network entity 502 that the tag's strength-measurement of the omnidirectional reference transmission in the first step 700 is greater than the certain threshold, then the first RFID tag 504a may refrain from transmitting a backscatter transmission in response to any of the directional beam transmissions in the second step 720. As such, the directional beam transmissions may be reserved for tags that are further away, and tags that are close (e.g., the first RFID tag 504a) may instead rely on omnidirectional transmissions.

It should be noted that the beam sweeping operation of the second step 720 may be performed in the time-domain. That is, each beam used by the network entity 502 for transmission may be used in series. For example, the network entity may transmit a signal via the first beam 704 within a first time window. At the completion of the first time window, the network entity may transmit another signal via the second beam 706 within a second time window. Accordingly, the transmission using one beam may not overlap with another transmission using another beam. By transmitting signaling via the codebook beams in the time domain, the network entity 502 can determine how many RFID tags 504 are transmitting a backscatter response to each beam.

Moreover, it should be noted that an RFID tag may transmit a backscatter signal in response to more than one directional beam transmission from the network entity 502. For example, if a tag measures a power that satisfies a threshold condition for more than one beam, then that tag may transmit a backscatter response for of the more than one beams.

### Examples of Channel Measurement Via Multi-Stage Beam Sweep

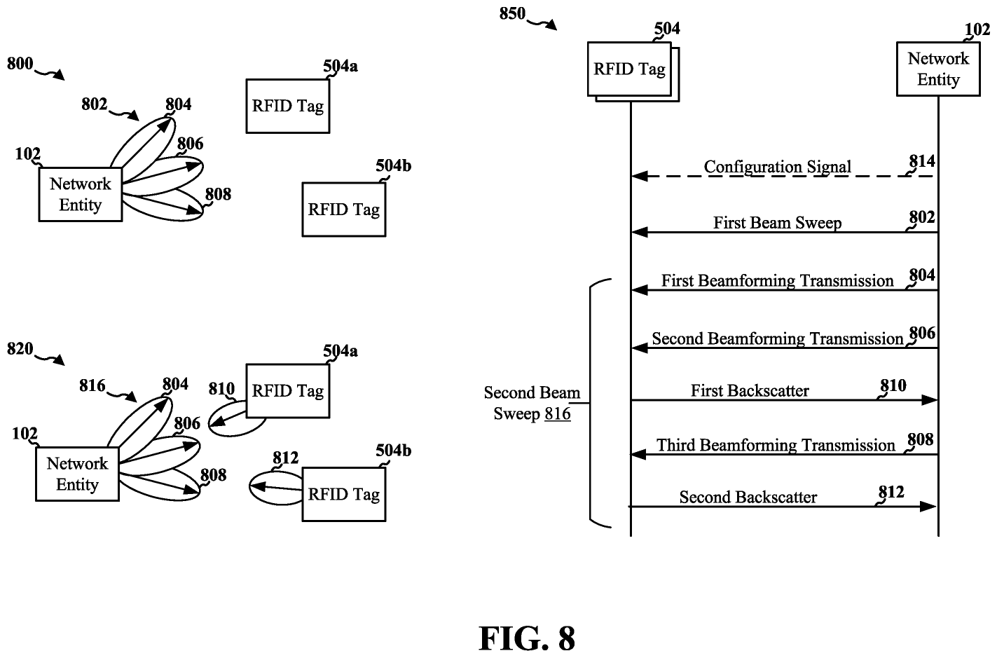

FIG. 8 is a block diagram and call-flow diagram 850 illustrating example wireless communications between a network entity 502 (e.g., base station 102/180 of FIGS. 1 and 3) and multiple RFID tags 504 (e.g., UE 104 of FIGS. 1 and 3; first RFID tag 504a and second RFID tag 504b).

Initially, the network entity 502 may transmit a configuration signal 814 to the multiple RFID tags 504. The configuration signal 814 may be configured to provide the RFID tags 504 with notice of a future beam sweep operation performed between the network entity 502 and the RFID tags 504. Similar to FIG. 7, the beam sweep operation of FIG. 8 may include a first step 800 and a second step 820. The configuration signal 814 may also indicate whether the beam sweep operation is an omni-directional transmission with a beam sweep (e.g., as illustrated in FIG. 7), or multiple stages of beam sweeping (as illustrated in FIG. 8). The configuration signal 814 may be transmitted via an omni-directional beam or a quasi-omni-directional beam.

At a first step 800 of the beam sweep operation, the network entity 502 may perform a first beam sweep 802 by transmitting signaling via multiple directional beams. The multiple directional beams may be defined by all or a subset of beamforming vectors stored in a codebook on the network entity 502. The tags 504 may receive signaling from the network entity 502 via one or more of the directional beams (e.g., a first beam 804, a second beam 806, a third beam 808), but in this example, the tags 504 may refrain from transmitting a backscatter signal back to the network entity 502. Instead, each of the tags 504 may measure the received power of the signaling associated with each beam direction. As such, each tag 504 may determine which directional beam provides the strongest and/or highest quality signaling.

For example, after transmitting the configuration signal 814, the network entity 502 may perform the first beam sweep 802. The first RFID tag 504a may determine that signaling received via the second beam 806 is the strongest and/or highest quality of the three beams. Similarly, the second RFID tag 504b may determine that signaling received via the third beam 808 is the strongest and/or highest quality of the three beams.

At a second step 820 of the beam sweep operation, the network entity 502 may begin a second beam sweep 816 using the same directional beams used in the first beam sweep 802. Each tag may backscatter only the one signal transmitted using the directional beam that was previously determined to provide the strongest and/or highest quality signaling. As described in FIG. 7, the backscatter signaling may be modulated by each tag to include a bit-sequence configured to identify a corresponding tag. The network entity 502 may receive the backscatter signals from the tags 504 and store the information. Accordingly, the network entity 502 may store information regarding which beams work best with certain tags and apply this information to future communications with the tags.

Continuing the example above, after completing the first beam sweep 802, the network entity 502 may perform the second beam sweep 816. The second beam sweep 816 may use the same beams of the first beam sweep and may start by transmitting a signal via the first beam 804. The network entity 502 may then transmit signaling via the second beam 806. The first RFID tag 504a may transmit a first backscatter signal 810 in response (e.g., because the first RFID tag 504a determined that the second beam 806 provided the strongest and/or highest quality signal during the first beam sweep 802). The network entity 502 may then transmit signaling via the third beam 808, and the second RFID tag 504b may transmit a second backscatter signal 812 in response (e.g., because the second RFID tag 504 determined that the third beam 808 provided the strongest and/or highest quality signal during the first beam sweep 802).

It should be noted that similar to the beam sweep of FIG. 7, the first beam sweep 802 and the second beam sweep 816 may be performed in the time-domain. The techniques described in FIG. 8 may be different from FIG. 7 because the tags may only transmit a backscatter signal in response to a single beamformed transmission from the network entity 502. Whereas, using the techniques of FIG. 7, the tags may respond to multiple beamformed signals. The techniques of FIG. 8 may be relatively more beneficial than FIG. 7 in scenarios where tags 504 are located at distances so far that omni-directional transmissions cannot reach them or provided them with enough power to measure signaling. Because directional beams have a relatively greater range compared to omni-directional beams, the techniques described in FIG. 8 may be more advantageous for overcoming larger distances between the network entity 502 and one or more tags 504.

In certain aspects, the tags 504 may be configured to backscatter signaling received from multiple beams if the received power associated with each of the multiple beams is similar. For example, the network entity 502 may configure the tags 504 with a threshold value (e.g., an integer) via the configuration signal 814. The network entity 502 may then perform the first beam sweep 802. If a tag determines that the difference between the highest received powers of signaling transmitted via multiple directional beams is less than or equal to the threshold value, then the tag may transmit a backscatter signal to the network entity in response to signaling transmitted via those beams during the second beam sweep 816.

For example, the network entity 502 may configure the tags 504 with a threshold value of 2 dBm. During the first beam sweep 802, the first RFID tag 504a measures signal strength of the first beam 804 as −10 dBm, signal strength of the second beam 806 as −9 dBm, and signal strength of the third beam 808 as −19 dBm. Because the difference of the signal strength between the first beam 804 and the second beam 806 is less than the threshold value, the first RFID tag 504a may transmit a backscatter signal in response to signaling transmitted via both the first beam 804 and the second beam 806 during the second beam sweep 816. Accordingly, a tag may transmit a backscatter signal in response to signaling from each of multiple beams so long as the received power is measured to be within a threshold from the highest measured signal. This technique may be advantageous for tags that relatively far away from the network entity 502 and are in the middle of two beams used by the network entity 502. The network entity may use one or more of the beams (e.g., beams that carried signals to which the tag responded with a backscatter signal) simultaneously for future communications with such tags.

In certain aspects, the threshold value discussed above may be determined by the network entity 502 and communicated to the tag via the configuration signal. In some examples, the threshold value may be dependent on the maximum received power as measured by a tag. For example, during the first beam sweep 802, the first RFID tag 504a may measure signal strength of the first beam 804 as −7 dBm, signal strength of the second beam 806 as −7 dBm, and signal strength of the third beam 808 as −9 dBm. In this case, a threshold value of 2 dBm may be too great, as it would include signaling transmitted via all three beams. Accordingly, the tag may reduce the threshold value to 1 dBm or 0 dBm based on the tag's signal measurements during the first beam sweep 802. This may prevent tags 504 from backscattering on many beams if they are close to the network entity 502 or in another location where they can receive a high-powered signal from multiple beams.

In certain aspects, the tags 504 may be configured to apply a frequency shift to backscatter signals they transmit back to the network entity 502. In some examples, the amount of frequency shift applied to a backscatter signal at each tag may be a function of the measured strength of the signal to which the tag is responding. Thus, the network entity 502 may determine which tags are close and which tags are relatively further away based on how much frequency shift is applied to each backscatter signal received by the network entity 502. Based on this information, the network entity 502 may conserve power by reducing transmission strength for close tags in future communications.

In certain aspects, the tags 504 may be configured to apply a certain sequence to backscatter signals they transmit back to the network entity 502 based on the measured strength of received signals. For example, the first RFID tag 504a, being closer to the network entity 502, may measure a received a signal via the second beam 806 and determine that the signal strength is relatively high. Thus, in the backscatter response, the first RFID tag 504a may select a particular sequence (e.g., a sequence root that corresponds to the measured signal strength) to embed in the backscatter response. In some examples, the tags 504 may be configured with a look-up table having particular sequence roots having a 1:1 correspondence to particular signal strength values. Accordingly, a sequence applied to a backscatter signal at each tag may be a function of the measured strength of the signal to which the tag is responding. Thus, the network entity 502 may determine which tags are close and which tags are relatively further away based on which sequence is applied to each backscatter signal received by the network entity 502. Based on this information, the network entity 502 may conserve power by reducing transmission strength for close tags in future communications.

In addition, or alternatively, one or more of the tags 504 may be configured to select a sequence to apply to a backscatter signal and apply the same sequence to each backscatter signal transmitted during the second beam sweep 816. By applying the same sequence to multiple backscatter transmissions, the tag may inform the network entity 502 that the same tag is providing multiple backscatter transmissions within the same beam sweep. The network entity 502 may include a look-up table associating certain sequences with a corresponding tag.

It should be noted that although FIGS. 7 and 8 illustrate examples of beam sweeps of three beams, any suitable number of beams may be used, including fewer or more beams than illustrated. Moreover, one or more of the features described in connection with FIG. 7 may be applied with equal force to the techniques described in FIG. 8, and vice versa.

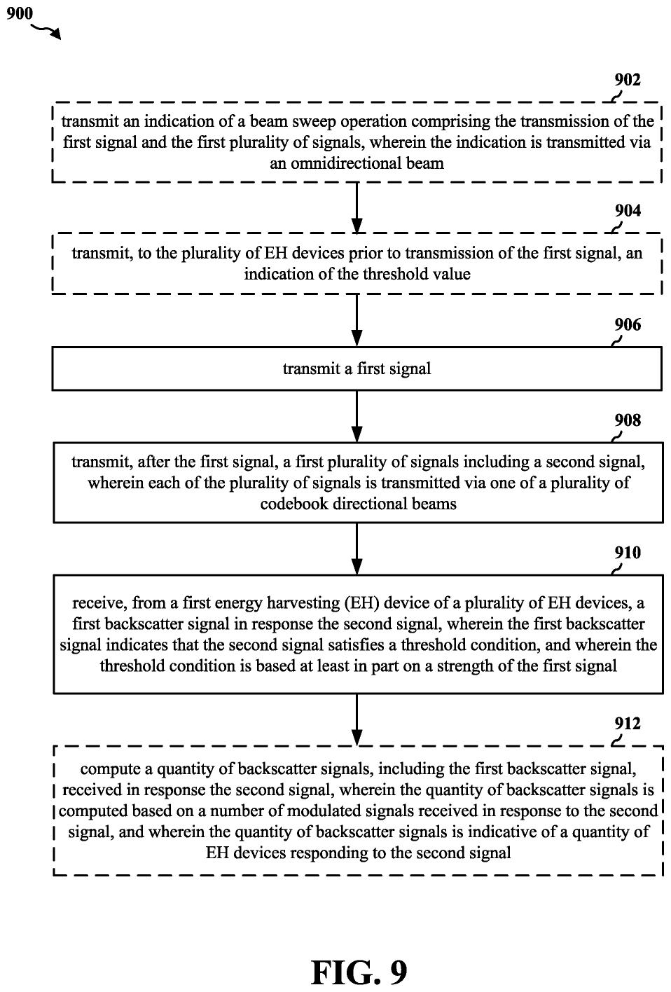

FIG. 9 is a flowchart 900 of a method of wireless communication. The method may be performed by a network entity (e.g., the base station 102/180 configured as an RFID reader; the apparatus 1002). At 902, the network entity may optionally transmit an indication of a beam sweep operation that comprises transmission of the first signal and the first plurality of signals, wherein the indication is transmitted via an omnidirectional beam. For example, 902 may be performed by a transmitting component 1040. Here, the network entity may transmit an indication of a beam sweep operation (e.g., as illustrated in FIGS. 7 and 8) to a plurality of EH devices (e.g., RFID tags). In some examples, the transmission may indicate whether the network entity will perform a beam sweep operation where the initial signaling is an omni-directional signal or a beam sweep of multiple directional beams.

At 904, the network entity may optionally transmit to the plurality of EH devices prior to transmission of the first signal, an indication of the threshold value. For example, 904 may be performed by the transmitting component 1040. Here, the network entity may transmit signaling (e.g., via an omni-directional or quasi-omni-directional beam) to a plurality of EH devices, information indicating a threshold value. The threshold value may correspond to a value that the tag may use to determine whether to respond to a signal from the network node (e.g., where the threshold value is an integer each tag may add to a measured power value of an omni-directional transmission (e.g., reference transmission) to determine whether a backscattered signal should be transmitted in response to a signal transmitted via a directional beam), as discussed in connection with FIG. 7. In some examples, the threshold value may correspond to a value that the tag may use to determine whether to refrain from transmitting a backscatter response to a signal transmitted via a directional beam (e.g., if the received power of the omni-directional transmission is greater than the threshold value, then the tag may refrain from responding to any directional transmissions), as discussed in connection with FIG. 7. In some examples, the threshold value may correspond to a value that the tag may use to determine whether to transmit a backscatter response to multiple directional beams, as discussed in connection with FIG. 8.

At 906, the network entity may transmit a first signal. For example, 906 may be performed by the transmitting component 1040. In certain aspects, the first signal may correspond to a transmission of a signal via an omni- or quasi-omni-directional beam, as discussed in relation to FIG. 7. In another aspect, the first signal may correspond to one of a plurality of signals transmitted via one of multiple directional beams during a first beam sweep, as discussed in relation to FIG. 8.

At 908, the network entity may transmit, after the first signal, a first plurality of signals including a second signal, wherein each of the plurality of signals is transmitted via one of a plurality of codebook directional beams. For example, 902 may be performed by the transmitting component 1040. Here, the network entity may transmit a plurality of signals, each via one of multiple directional beams during a beam sweep, as discussed in FIG. 7, or during a second beam sweep as discussed in FIG. 8.

At 910, the network entity may receive, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal. For example, 902 may be performed by a receiving component 1042. Here, the network entity may receive one or more backscatter signals from one or more tags in response to a signal transmitted via a directional beam in a beam sweep. Whether the tags respond to any of the directional beam signals may depend on whether the strength of the transmitted signal satisfies a threshold condition. In one example, FIG. 7 describes a scenario, among many others, where the tag will only respond if the strength of the omni-directional signaling (e.g., the first signal) is greater than or equal to a power threshold. In another example, FIG. 8 describes a scenario, among many others, where the tag may respond to a directional signal transmission from the network entity if the directional signal is the strongest signal (e.g., the first signal) among the multiple beams measured during a first beam sweep.

At 912, the network entity may optionally compute a quantity of backscatter signals, including the first backscatter signal, received in response the second signal, wherein the quantity of backscatter signals is computed based on a number of modulated signals received in response to the second signal, and wherein the quantity of backscatter signals is indicative of a quantity of EH devices responding to the second signal. For example, 912 may be performed by a computing component 1044. Here, the network entity may compute a number of unique tags backscattering a response signal to the network entity for a particular directional beam. The network entity may use the information to determine how many tags can receive a future communication via the particular beam.

In certain aspects, the first signal is transmitted via an omni-directional beam.

In certain aspects, the threshold condition is satisfied if a strength of the second signal is greater than or equal to a threshold value.

In certain aspects, the indication of the threshold value is transmitted via an omnidirectional beam.

In certain aspects, the threshold value is a function of the strength of the first signal.

In certain aspects, the first backscatter signal comprises at least one of: a modulated signal based on the second signal, wherein the modulation is one of an amplitude-shift keying (ASK), a frequency-shift keying (FSK), or an on-off-keying (OOK); and a frequency shift relative to the second signal.

In certain aspects, the modulated signal is configured to identify the first EH device.

In certain aspects, the first plurality of signals is transmitted as a part of a time-domain beam sweep of the plurality of codebook directional beams.

In certain aspects, the first signal is transmitted as part of a first time-domain beam sweep of the plurality of codebook directional beams, and wherein the first plurality of signals is transmitted as a part of a second time-domain beam sweep of the plurality of codebook directional beams.

In certain aspects, the first signal and the second signal are transmitted via a first beam.

In certain aspects, the threshold condition is satisfied if the strength of the second signal is within a threshold value defined by the strength of the first signal. For example, the tag may measure a plurality of signals transmitted by a network entity for a first beam sweep, wherein the highest power signal of the first beam sweep is measured as −6 dBm. Accordingly, during a second beam sweep, the tag may backscatter a signal received at the same strength or within a threshold value (e.g., ±0.5 dBm, or any other suitable value depending on the codebook used by the network entity, environment, etc.) of the highest power signal of the first beam sweep. Thus, in this example, the tag may backscatter a signal having a measured strength between −5.5 and −6.5 dBm.

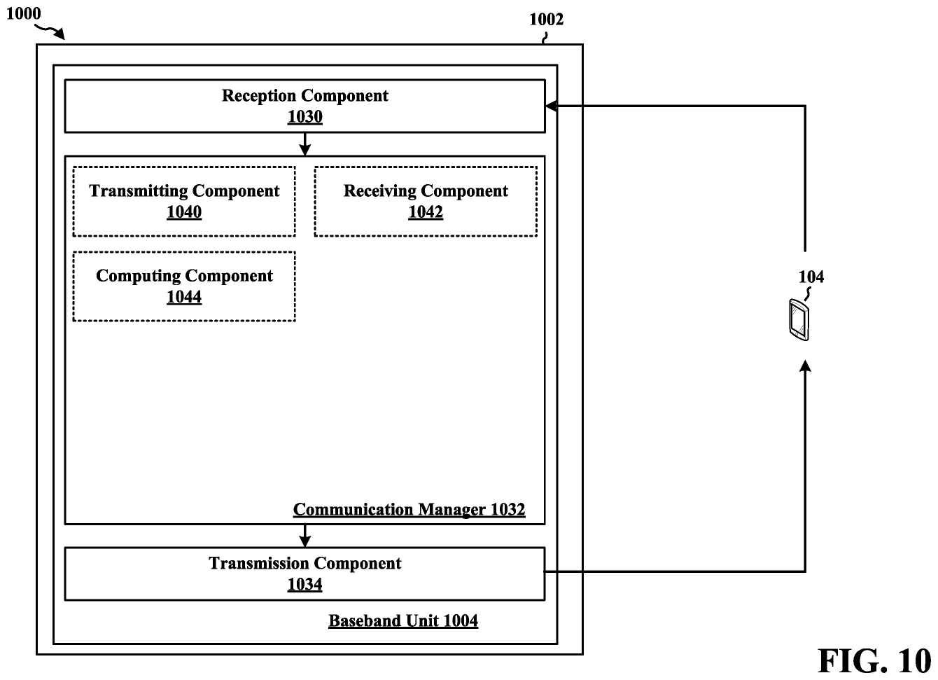

FIG. 10 is a diagram 1000 illustrating an example of a hardware implementation for an apparatus 1002. The apparatus 1002 is a network entity or base station 102/180 and includes a baseband unit 1004. The baseband unit 1004 may communicate through a cellular RF transceiver with a UE 104 (e.g., an EH device or RFID tag 504). The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the network entity or base station 102/180 and may include the memory 376 and/or at least one of the TX processor 316, the RX processor 370, and the controller/processor 375. In various examples, the apparatus 1002 can be a chip, SoC, chipset, package or device that may include: one or more modems (such as a Wi-Fi (IEEE 802.11) modem or a cellular modem such as 3GPP 4G LTE or 5G compliant modem); one or more processors, processing blocks or processing elements (collectively “the processor”); one or more radios (collectively “the radio”); and one or more memories or memory blocks (collectively “the memory”).

The communication manager 1032 includes a transmitting component 1040 that is configured to transmit an indication of a beam sweep operation that comprises transmission of the first signal and the first plurality of signals, wherein the indication is transmitted via an omnidirectional beam; transmit, to the plurality of EH devices prior to transmission of the first signal, an indication of the threshold value; transmit a first signal; and transmit, after the first signal, a first plurality of signals including a second signal, wherein each of the plurality of signals is transmitted via one of a plurality of codebook directional beams; e.g., as described in connection with 902, 904, 906, 908 of FIG. 9.

The communication manager 1032 further includes a receiving component 1042 configured to receive, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal; e.g., as described in connection with 910 of FIG. 9.

The communication manager 1032 further includes a computing component 1044 configured to compute a quantity of backscatter signals, including the first backscatter signal, received in response the second signal, wherein the quantity of backscatter signals is computed based on a number of modulated signals received in response to the second signal, and wherein the quantity of backscatter signals is indicative of a quantity of EH devices responding to the second signal; e.g., as described in connection with 912 of FIG. 9.

The apparatus may include additional components that perform each of the blocks of the algorithm in the aforementioned flowchart of FIG. 9. As such, each block in the aforementioned flowchart may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1002, and in particular the cellular baseband processor 1004, includes means for transmitting an indication of a beam sweep operation that comprises transmission of the first signal and the first plurality of signals, wherein the indication is transmitted via an omnidirectional beam; means for transmitting, to the plurality of EH devices prior to transmission of the first signal, an indication of the threshold value; means for transmitting a first signal; means for transmitting, after the first signal, a first plurality of signals including a second signal, wherein each of the plurality of signals is transmitted via one of a plurality of codebook directional beams; means for receiving, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal; and means for computing a quantity of backscatter signals, including the first backscatter signal, received in response the second signal, wherein the quantity of backscatter signals is computed based on a number of modulated signals received in response to the second signal, and wherein the quantity of backscatter signals is indicative of a quantity of EH devices responding to the second signal.

The aforementioned means may be one or more of the aforementioned components of the apparatus 1002 configured to perform the functions recited by the aforementioned means. As described supra, the apparatus 1002 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

In some examples, the means for transmitting may include the TX processor 316 and the antenna 320. Means for receiving may include the RX processor 370 and the antenna 320. Means for computing may include the controller processor 375.

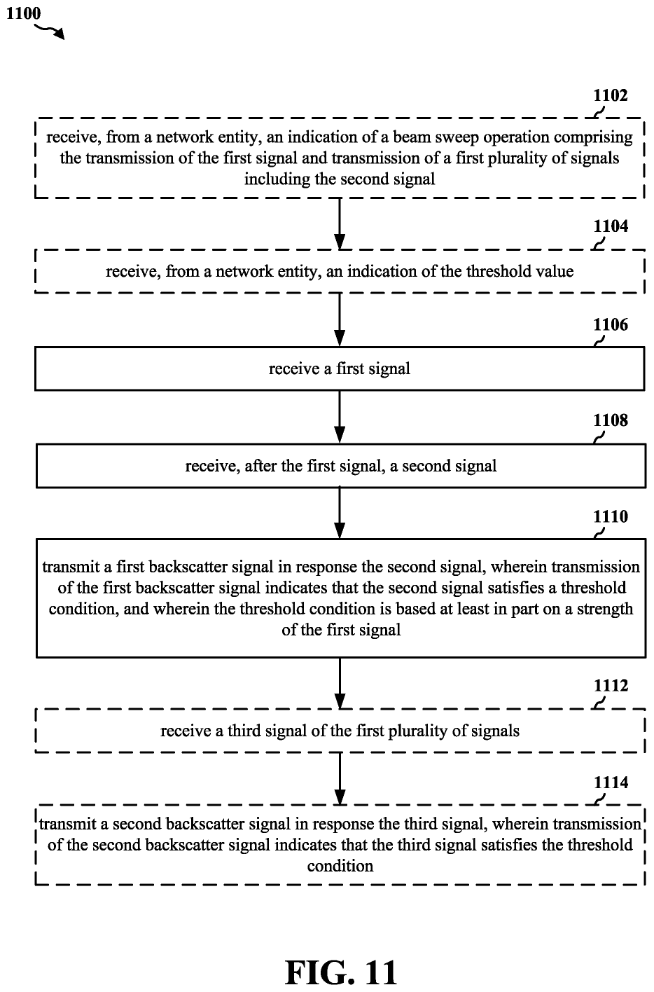

FIG. 11 is a flowchart 1100 of a method of wireless communication. The method may be performed by an apparatus (e.g., the UE 104 configured as an EH device, such as an RFID tag 504; the apparatus 1202). At 1102, the EH device may optionally receive, from a network entity, an indication of a beam sweep operation that comprises transmission of the first signal and transmission of a first plurality of signals including the second signal. For example, 902 may be performed by a receiving component 1240. Here, the network entity may transmit an indication of a beam sweeping operation taking place in the future.

At 1104, the EH device may optionally receive, from a network entity, an indication of the threshold value. For example, 1104 may be performed by the receiving component 1240.

At 1106, the EH device may receive a first signal. For example, 1106 may be performed by the receiving component 1240. Here, the first signal may be one of a signal transmitted via an omni-directional beam, or be one of a plurality of signals transmitted in a beam sweep.

At 1108, the EH device may receive, after the first signal, a second signal. For example, 1108 may be performed by the receiving component 1240.

At 1110, the EH device may transmit a first backscatter signal in response the second signal, wherein transmission of the first backscatter signal indicates that the second signal satisfies a threshold condition, and wherein the threshold condition is based at least in part on a strength of the first signal. For example, 1110 may be performed by a transmitting component 1242.

At 1112, the EH device may optionally receive a third signal of the first plurality of signals. For example, 1112 may be performed by the receiving component 1240. Here, the EH device may receive multiple signals each transmitted via a directional beam. In this example, the EH device may receive both the second signal and the third signal as part of a beam sweep.

Finally, at 1114, the EH device may optionally transmit a second backscatter signal in response the third signal, wherein transmission of the second backscatter signal indicates that the third signal satisfies the threshold condition. For example, 1114 may be performed by the transmitting component 1242. Here, the EH device may transmit a backscatter signal in response to multiple signals from different beams transmitted by the network entity.

In certain aspects, the threshold condition is satisfied if a strength of the second signal is greater than or equal to a threshold value.

In certain aspects, the threshold value is a function of the strength of the first signal.

In certain aspects, the first backscatter signal comprises at least one of: a modulated signal based on the second signal, wherein the modulation is one of an amplitude-shift keying (ASK), a frequency-shift keying (FSK), or an on-off-keying (OOK); and a frequency shift relative to the second signal.

In certain aspects, the first backscatter signal is transmitted with a first frequency shift based on a signal strength of the second signal, and wherein the second backscatter signal is transmitted with a second frequency shift based on a signal strength of the third signal.

In certain aspects, the first backscatter signal is transmitted with a first sequence based on a signal strength of the second signal, and wherein the second backscatter signal is transmitted with a second sequence based on a signal strength of the third signal.

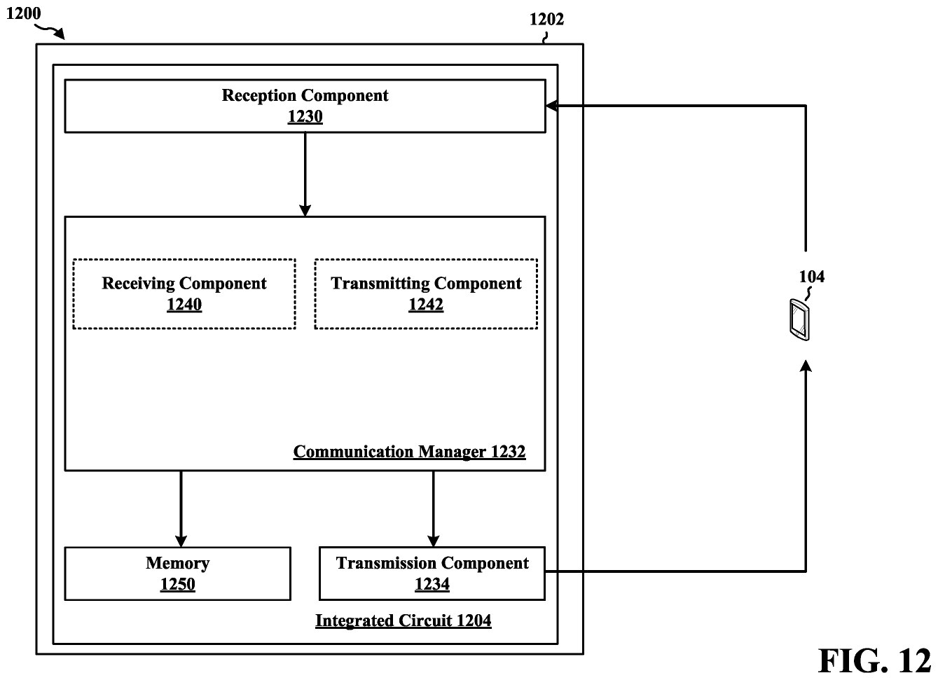

FIG. 12 is a diagram 1200 illustrating an example of a hardware implementation for an apparatus 1202. The apparatus 1202 is a UE implemented as an EH device (such as an RFID tag) and includes an integrated circuit 1204 comprising an RF front end (e.g., reception component 1230 and transmission component 1234) and a memory 1250. The RF front end provides the apparatus with a capability to receive signals from an RF source and/or an RFID reader and transmit backscattered signals in response.

The communication manager 1232 includes a receiving component 1240 that is configured to receive, from a network entity, an indication of a beam sweep operation that comprises transmission of the first signal and transmission of a first plurality of signals including the second signal; receive, from a network entity, an indication of the threshold value; receive a first signal; receive, after the first signal, a second signal; and, receive a third signal of the first plurality of signals; e.g., as described in connection with 1102, 1104, 1106, 1108, and 1112.

The communication manager 1232 includes a transmitting component 1242 that is configured to transmit a first backscatter signal in response the second signal, wherein transmission of the first backscatter signal indicates that the second signal satisfies a threshold condition, and wherein the threshold condition is based at least in part on a strength of the first signal; transmit a second backscatter signal in response the third signal, wherein transmission of the second backscatter signal indicates that the third signal satisfies the threshold condition; e.g., as described in connection with 1110, and 1114.

The apparatus may include additional components that perform each of the blocks of the algorithm in the aforementioned flowchart of FIG. 11. As such, each block in FIG. 12 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1202, and in particular the integrated circuit 1204, includes means for receiving, from a network entity, an indication of a beam sweep operation that comprises transmission of the first signal and transmission of a first plurality of signals including the second signal; means for receiving, from a network entity, an indication of the threshold value; means for receiving a first signal; means for receiving, after the first signal, a second signal; means for transmitting a first backscatter signal in response the second signal, wherein transmission of the first backscatter signal indicates that the second signal satisfies a threshold condition, and wherein the threshold condition is based at least in part on a strength of the first signal; means for receiving a third signal of the first plurality of signals; means for transmitting a second backscatter signal in response the third signal, wherein transmission of the second backscatter signal indicates that the third signal satisfies the threshold condition.

In some examples, the means for transmitting may include the antenna 352 and the receiver/transmitter 354. Means for receiving may also include the antenna 352 and the receiver/transmitter 354. Means for computing, means for determining, means for looking up information, means for storing information, and means for computing may include the MCU 359.

### Additional Considerations

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a memory, at least one memory, and/or one or more memories, individually or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

### Example Aspects

The following examples are illustrative only and may be combined with aspects of other embodiments or teachings described herein, without limitation.

Clause 1. A method for wireless communication at a network entity, comprising: transmitting a first signal; transmitting, after the first signal, a first plurality of signals including a second signal, wherein each of the plurality of signals is transmitted via one of a plurality of codebook directional beams; and receiving, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal.

Clause 2. The method of clause 1, wherein the method further comprises: transmitting an indication of a beam sweep operation comprising the transmission of the first signal and the first plurality of signals, wherein the indication is transmitted via an omnidirectional beam.

Clause 3. The method of any of clauses 1 and 2, wherein the first signal is transmitted via an omni-directional beam.

Clause 4. The method of any of clauses 1-3, wherein the threshold condition is satisfied if a strength of the second signal is greater than or equal to a threshold value.

Clause 5. The method of clause 4, wherein the method further comprises: transmitting, to the plurality of EH devices prior to transmission of the first signal, an indication of the threshold value.

Clause 6. The method of clause 5, wherein the indication of the threshold value is transmitted via an omnidirectional beam.

Clause 7. The method of any of clauses 5 and 6, wherein the threshold value is a function of the strength of the first signal.

Clause 8. The method of any of clauses 1-7, wherein the first backscatter signal comprises at least one of: a modulated signal based on the second signal, wherein the modulation is one of an amplitude-shift keying (ASK), a frequency-shift keying (FSK), or an on-off-keying (OOK); and a frequency shift relative to the second signal.

Clause 9. The method of clause 8, wherein the modulated signal is configured to identify the first EH device.

Clause 10. The method of any of clauses 8 and 9, wherein the method further comprises: computing a quantity of backscatter signals, including the first backscatter signal, received in response the second signal, wherein the quantity of backscatter signals is computed based on a number of modulated signals received in response to the second signal, and wherein the quantity of backscatter signals is indicative of a quantity of EH devices responding to the second signal.

Clause 11. The method of any of clauses 1-10, wherein the first plurality of signals is transmitted as a part of a time-domain beam sweep of the plurality of codebook directional beams.

Clause 12. The method of any of clauses 1-11, wherein the first signal is transmitted as part of a first time-domain beam sweep of the plurality of codebook directional beams, and wherein the first plurality of signals is transmitted as a part of a second time-domain beam sweep of the plurality of codebook directional beams.

Clause 13. The method of any of clauses 1-12, wherein the first signal and the second signal are transmitted via a first beam.

Clause 14. The method of clause 13, wherein the threshold condition is satisfied if the strength of the second signal is within a threshold value defined by the strength of the first signal.

Clause 15. A method of wireless communication at an energy harvesting (EH) device, comprising: receiving a first signal; receiving, after the first signal, a second signal; and transmitting a first backscatter signal in response the second signal, wherein transmission of the first backscatter signal indicates that the second signal satisfies a threshold condition, and wherein the threshold condition is based at least in part on a strength of the first signal.

Clause 16. The method of clause 15, wherein the method further comprises: receiving, from a network entity, an indication of a beam sweep operation comprising the transmission of the first signal and transmission of a first plurality of signals including the second signal.

Clause 17. The method of any of clauses 15 and 16, wherein the threshold condition is satisfied if a strength of the second signal is greater than or equal to a threshold value.

Clause 18. The method of clause 17, wherein the method further comprises: receiving, from a network entity, an indication of the threshold value.

Clause 19. The method of clause 18, wherein the threshold value is a function of the strength of the first signal.

Clause 20. The method of any of clauses 15-19, wherein the first backscatter signal comprises at least one of: a modulated signal based on the second signal, wherein the modulation is one of an amplitude-shift keying (ASK), a frequency-shift keying (FSK), or an on-off-keying (OOK); and a frequency shift relative to the second signal.

Clause 21. The method of any of clauses 15-20, wherein the second signal is received as part of a beam sweep operation comprising transmission of a first plurality of signals including the second signal, and wherein the method further comprises: receiving a third signal of the first plurality of signals; and transmitting a second backscatter signal in response the third signal, wherein transmitting the second backscatter signal indicates that the third signal satisfies the threshold condition.

Clause 22. The method of clause 21, wherein the first backscatter signal is transmitted with a first frequency shift based on a signal strength of the second signal, and wherein the second backscatter signal is transmitted with a second frequency shift based on a signal strength of the third signal.

Clause 23. The method of any of clauses 21 and 22, wherein the first backscatter signal is transmitted with a first sequence based on a signal strength of the second signal, and wherein the second backscatter signal is transmitted with a second sequence based on a signal strength of the third signal.

Clause 24. A network entity comprising: one or more memories, individually or in combination, having instructions; and one or more processors, individually or in combination, configured to execute the instructions and cause the apparatus to perform the method of any of clauses 1-14.

Clause 25. An energy harvesting (EH) device comprising: one or more memories, individually or in combination, having instructions; and one or more processors, individually or in combination, configured to execute the instructions and cause the EH to perform the method of any of clauses 15-23.

Clause 26. A network entity comprising: one or more means for performing the method of any of clauses 1-14.

Clause 27. An EH device comprising: one or more means for performing the method of any of clauses 15-23.

Clause 28. A non-transitory computer-readable storage medium having instructions stored thereon for performing the method of any of claims 1-14 for wireless communication by a network entity.

Clause 29. A non-transitory computer-readable storage medium having instructions stored thereon for performing the method of any of claims 15-23 for wireless communication by an EH device.

What is claimed is:

1. A network entity configured for wireless communication, comprising:
one or more memories, individually or in combination, having instructions; and
one or more processors, individually or in combination, configured to execute the instructions and cause the network entity to:
transmit a first signal;
transmit, after the first signal, a first plurality of signals including a second signal, wherein each of the plurality of signals is transmitted via one of a plurality of codebook directional beams; and
receive, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal.

2. The network entity of claim 1, wherein the one or more processors, individually or in combination, are further configured to execute the instructions and cause the network entity to:
transmit an indication of a beam sweep operation that comprises transmission of the first signal and the first plurality of signals, wherein the indication is transmitted via an omnidirectional beam.

3. The network entity of claim 1, wherein the first signal is transmitted via an omni-directional beam.

4. The network entity of claim 1, wherein the threshold condition is satisfied if a strength of the second signal is greater than or equal to a threshold value.

5. The network entity of claim 4, wherein the one or more processors, individually or in combination, are further configured to execute the instructions and cause the network entity to:
transmit, to the plurality of EH devices prior to transmission of the first signal, an indication of the threshold value.

6. The network entity of claim 5, wherein the indication of the threshold value is transmitted via an omnidirectional beam.

7. The network entity of claim 5, wherein the threshold value is a function of the strength of the first signal.

8. The network entity of claim 1, wherein the first backscatter signal comprises at least one of:
a modulated signal based on the second signal, wherein the modulation is one of an amplitude-shift keying (ASK), a frequency-shift keying (FSK), or an on-off-keying (OOK); and
a frequency shift relative to the second signal.

9. The network entity of claim 8, wherein the modulated signal is configured to identify the first EH device.

10. The network entity of claim 8, wherein the one or more processors, individually or in combination, are further configured to execute the instructions and cause the network entity to:
compute a quantity of backscatter signals, including the first backscatter signal, received in response the second signal, wherein the quantity of backscatter signals is computed based on a number of modulated signals received in response to the second signal, and wherein the quantity of backscatter signals is indicative of a quantity of EH devices responding to the second signal.

11. The network entity of claim 1, wherein the first plurality of signals is transmitted as a part of a time-domain beam sweep of the plurality of codebook directional beams.

12. The network entity of claim 1, wherein the first signal is transmitted as part of a first time-domain beam sweep of the plurality of codebook directional beams, and wherein the first plurality of signals is transmitted as a part of a second time-domain beam sweep of the plurality of codebook directional beams.

13. The network entity of claim 1, wherein the first signal and the second signal are transmitted via a first beam.

14. The network entity of claim 13, wherein the threshold condition is satisfied if the strength of the second signal is within a threshold value defined by the strength of the first signal.

15. An energy harvesting (EH) device, comprising:
one or more memories, individually or in combination, having instructions; and
one or more processors, individually or in combination, configured to execute the instructions and cause the EH device to:
receive a first signal;
receive, after the first signal, a second signal; and
transmit a first backscatter signal in response the second signal, wherein transmission of the first backscatter signal indicates that the second signal satisfies a threshold condition, and wherein the threshold condition is based at least in part on a strength of the first signal.

16. The EH device of claim 15, wherein the one or more processors, individually or in combination, are further configured to execute the instructions and cause the EH device to:
receive, from a network entity, an indication of a beam sweep operation that comprises transmission of the first signal and transmission of a first plurality of signals including the second signal.

17. The EH device of claim 15, wherein the threshold condition is satisfied if a strength of the second signal is greater than or equal to a threshold value.

18. The EH device of claim 17, wherein the one or more processors, individually or in combination, are further configured to execute the instructions and cause the EH device to:
receive, from a network entity, an indication of the threshold value.

19. The EH device of claim 18, wherein the threshold value is a function of the strength of the first signal.

20. The EH device of claim 15, wherein the first backscatter signal comprises at least one of:
a modulated signal based on the second signal, wherein the modulation is one of an amplitude-shift keying (ASK), a frequency-shift keying (FSK), or an on-off-keying (OOK); and
a frequency shift relative to the second signal.

21. The EH device of claim 15, wherein the second signal is received as part of a beam sweep operation comprising transmission of a first plurality of signals including the second signal, and wherein the one or more processors, individually or in combination, are further configured to execute the instructions and cause the EH device to:
receive a third signal of the first plurality of signals; and
transmit a second backscatter signal in response the third signal, wherein transmission of the second backscatter signal indicates that the third signal satisfies the threshold condition.

22. The EH device of claim 21, wherein the first backscatter signal is transmitted with a first frequency shift based on a signal strength of the second signal, and wherein the second backscatter signal is transmitted with a second frequency shift based on a signal strength of the third signal.

23. The EH device of claim 21, wherein the first backscatter signal is transmitted with a first sequence based on a signal strength of the second signal, and wherein the second backscatter signal is transmitted with a second sequence based on a signal strength of the third signal.

24. A method for wireless communication at a network entity, comprising:
transmitting a first signal;
transmitting, after the first signal, a first plurality of signals including a second signal, wherein each of the plurality of signals is transmitted via one of a plurality of codebook directional beams; and
receiving, from a first energy harvesting (EH) device of a plurality of EH devices, a first backscatter signal in response the second signal, wherein the first backscatter signal indicates that the second signal satisfies a threshold condition, and wherein the threshold condition is based at least in part on a strength of the first signal.

25. The method of claim 24, wherein the method further comprises:
transmitting an indication of a beam sweep operation comprising the transmission of the first signal and the first plurality of signals, wherein the indication is transmitted via an omnidirectional beam.

26. The method of claim 24, wherein the first signal is transmitted via an omni-directional beam.

27. The method of claim 24, wherein the threshold condition is satisfied if a strength of the second signal is greater than or equal to a threshold value.

28. The method of claim 27, wherein the method further comprises:
transmitting, to the plurality of EH devices prior to transmission of the first signal, an indication of the threshold value.

29. The method of claim 28, wherein the indication of the threshold value is transmitted via an omnidirectional beam.

30. A method of wireless communication at an energy harvesting (EH) device, comprising:
receiving a first signal;
receiving, after the first signal, a second signal; and
transmitting a first backscatter signal in response the second signal, wherein transmission of the first backscatter signal indicates that the second signal satisfies a threshold condition, and wherein the threshold condition is based at least in part on a strength of the first signal.
